(19) United States
(12) Patent Application Publication
(10) Pub. No.: US 2011/0313866 A1
(43) Pub. Date: Dec. 22, 2011

(54) SYSTEM AND METHOD FOR DETERMINING A VALUE OF A DATA-PROVIDING SERVICE UPGRADE

(75) Inventor: Jong Ho Park, Seongnam-si (KR)

(73) Assignee: NHN BUSINESS PLATFORM CORPORATION, Seongnam-si (KR)

(21) Appl. No.: 13/148,910

(22) PCT Filed: Feb. 10, 2010
(86) PCT No.: PCT/KR10/00834

§ 371 Date: Aug. 10, 2011

(30) Foreign Application Priority Data
Feb. 10, 2009 (KR) 10-2009-0010549

(51) Int. Cl. G06Q 30/00

(52) U.S. Cl. 705/14.69; 705/14.4

(57) ABSTRACT

A system and a method for determining a value of an advertisement data-providing service upgrade are disclosed. The system for determining a value of an advertisement data-providing service upgrade extracts advertisement data from a database to provide an advertisement service for registering and displaying the advertisement data of an advertiser, determines a value of upgrading the service of the extracted advertisement data, and proposes a service upgrade to the advertiser using the extracted advertisement data and the upgrade value.

### CROSS-REFERENCE TO RELATED APPLICATIONS

This application is the National Stage Entry of International Application: PCT/KR2010/000834, filed on Feb. 10, 2010, and claims priority from and the benefit of Korean Patent Application No. 10-2009-0010549, filed on Feb. 10, 2009, both of which are incorporated herein by reference for all purposes as if fully set forth herein.

### BACKGROUND OF THE INVENTION

1. Field of the Invention

The present invention relates to a system and method for determining a switching value for switching a service state of advertisement data.

2. Discussion of the Background

A locale registration service may accept a registration of information for each enterprise of a locale and display the information. For example, an enterprise may be effectively advertised by accepting registration of information about the enterprises located around Gangnam station and displaying the registered information to a user when a query including “Gangnam station” is inputted. The service may be provided for a fee or free of charge, and may be used for cross-selling of merchandise advertised in a locale by extracting advertisement data registered in a free locale registration service. A service provided for a fee may be switched to a premium service that provides a relatively high quality service at a relatively high price.

Accordingly, there is a desire for motivating an advertiser who registered free of charge to switch from a free service to a charged service or motivating an advertiser charged a registration fee to switch from a charged service to a premium service at a relatively high price.

### SUMMARY OF THE INVENTION

Exemplary embodiments of the present invention provide a system and method for determining a switching value that may improve an advertising value of an advertiser by determining a switching value for switching a service state of advertisement data and transmitting, to the advertiser, suggested information for switching the service state using the switching value.

Exemplary embodiments of the present invention provide a system and method for determining a switching value that may improve profitability by switching a service state by means of providing an advertiser with a switching value for switching a service state of advertisement data and promoting switching of a service state through various schemes.

Exemplary embodiments of the present invention provide a system and method for determining a switching value that may enhance a possibility of switching a service by providing objective data that enables an advertiser to verify profitability of switching a service state by means of providing a switching value for switching from a free service to a charged service to an advertiser registered free of charge or providing a switching value for switching from a charged service to a service at a relatively high price to an advertiser who is charged a relatively low registration fee.

Exemplary embodiments of the present invention provide a system and method that may be used for selecting target data for suggesting an additional fee for changing a display attribute of data, for example, an advertisement for which an advertiser has already paid a fee.

According to exemplary embodiments of the present invention, there is provided a system for determining a value, the system including a data extractor to extract advertisement data of an advertiser, from a database, to provide an advertisement service for registering and displaying the advertisement data, a value determining unit to determine a switching value for switching a service state of the extracted advertisement data, and a storage unit to store the extracted advertisement data related to the switching value.

The system for determining a value may further include an arranging unit to arrange the advertisement data according to a magnitude of the switching value.

The system for determining a value may further include a data verification unit to verify, from the storage unit, a switching value for switching a service state of the advertisement data, and a suggested-information transmitter to transmit suggested information for switching a service state using the switching value.

According to exemplary embodiments of the present invention, there is provided a method of determining a value, the method including extracting advertisement data, from a database, to provide an advertisement service for registering and displaying the advertisement data, determining a switching value for switching a service state of the extracted advertisement data, and storing the extracted advertisement data related to the switching value.

The method of determining a value may include arranging the advertisement data according to a magnitude of the switching value.

The method of determining a value may include verifying the switching value for switching a service state of the advertisement data, and transmitting suggested information for switching a service state using the verified switching value.

An exemplary embodiment of the present invention discloses a system for determining an advertising value of an advertiser. The system includes determining a switching value for switching a service state of an advertisement data and transmitting, to the advertiser, suggested information for switching the service state using the switching value.

An exemplary embodiment of the present invention discloses a method of improving profitability of switching a service state by providing an advertiser with a switching value for switching a service state of advertisement data and promoting switching of a service state through various schemes.

An exemplary embodiment of the present invention discloses a method of enhancing a possibility of switching a service by providing objective data that enables an advertiser to verify profitability of switching a service state by means of providing a switching value for switching from a free service to a charged service to an advertiser registered free of charge or providing a switching value for switching from a charged service to a service at a relatively high price to an advertiser who is charged a relatively low registration fee.

### BRIEF DESCRIPTION OF THE DRAWINGS

FIG. 1 is an example of an overall configuration of a system for determining a value according to an exemplary embodiment of the present invention.

FIG. 2 is a block diagram illustrating an internal configuration of a system for determining a value according to an exemplary embodiment of the present invention.

FIG. 3 is an example of arranging data according to a switching value determined by a system for determining a value according to an exemplary embodiment of the present invention.

FIG. 4 is a flowchart illustrating a method of determining a value according to an exemplary embodiment of the present invention.

FIG. 5 is a diagram illustrating an example in which advertisement data of an advertiser registered free of charge, advertisement data of an advertiser who is charged a registration fee, and advertisement data of an advertiser registered as a premium service user are displayed in a search result according to an exemplary embodiment of the present invention.

FIG. 6 is a diagram illustrating another example in which advertisement data of an advertiser is displayed in a search result according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

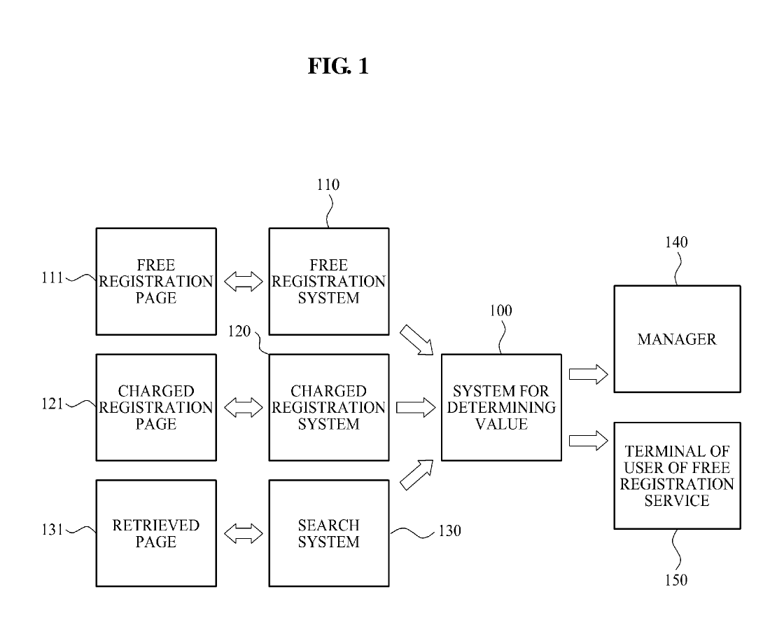

FIG. 1 is an example of an overall configuration of a system for determining a value 100 according to an exemplary embodiment of the present invention. Referring to FIG. 1, the system for determining a value 100 according to an exemplary embodiment of the present invention may be linked to a free registration system 110, a charged registration system 120, and a search system 130 or be included in one of the free registration system 110, the charged registration system 120, and the search system 130.

The free registration system 110 may register advertisement data from an advertiser using a free registration service and display the advertisement data on a free registration page 111, and the charged registration system 120 may register advertisement data from an advertiser using a charged registration service and display the advertisement data through a charged registration page 121. The search system 130 may receive a query input by an advertiser of a search service, and provide a search result corresponding to the query to the advertiser of the search service. In this instance, when advertisement data corresponding to the query is registered, the free registration system 110 and the charged registration system 120 may affect the corresponding advertisement data to be displayed through the search system 130. For example, when the free registration system 110 and the charged registration system 120 correspond to systems accepting registration of advertisement data related to an enterprise in a locale, “Nonhyeon station” is included in the query, and advertisement data associated with an enterprise located around “Nonhyeon station” is registered in the free registration system 110 or the charged registration system 120. Here, the corresponding advertisement data may be transmitted to the search system 130, thereby affecting the advertisement data to be displayed on a retrieved page 131 that provides a search result. In this case, an advertiser of a search service may obtain information about an enterprise located around “Nonhyeon station” as a search result.

In this instance, the system for determining a value 100 according to an exemplary embodiment of the present invention may determine an order of priority of advertisement data registered free of charge by determining a switching value corresponding to the advertisement data registered through the free registration system 110. In this specification, descriptions are mainly directed to an example of registering advertisement data for a fee to an advertiser registering advertisement data free of charge. However, descriptions may also be applied to an example of inducing an advertiser registering advertisement data for a fee to switch to a premium service of a relatively high quality by paying an additional fee for a better advertisement service.

According to an exemplary embodiment of the present invention, a switching value may denote a value for switching a service state of advertisement data of an advertiser. That is, the switching value may denote a value that may be obtained by an advertiser or be obtained by an advertisement registration system when a current service state of advertisement data of the advertiser is changed to another service state.

For example, the switching value may denote an indicator indicating a descending order of sales obtained by an operator of the advertisement registration system when an advertiser registered free of charge is switched to an advertiser registered for a fee. Here, the switching value may denote a value obtained by an advertiser when the advertiser registered free of charge is switched to an advertiser registered for a fee. For example, when a number of expected clicks per day is “100” in a case of registering free of charge and a number of expected clicks per day is “1000” in a case of registering for a fee, a difference of “900” in a number of expected clicks per day may be the switching value for the advertiser of an enterprise. In this example, the switching value may denote a value obtained by the operator of the advertisement registration system or the advertiser when the advertiser currently registered for a fee switches to a premium service by paying an additional fee.

The switching value used as an order of priority may be provided to a manager 140 and be used as information for determining an order of priority of advertisement sales. The switching value may be provided to a terminal of an advertiser using a free registration service 150 and be used as a criterion for discriminating an advertiser for a charged advertisement registration. The switching value may be used to transmit suggested information for registering an advertisement for a fee to an advertiser registered free of charge.

A service provided through “http://localshop.naver.com/LSPC0101.jsp” may be included in the scope of the present invention.

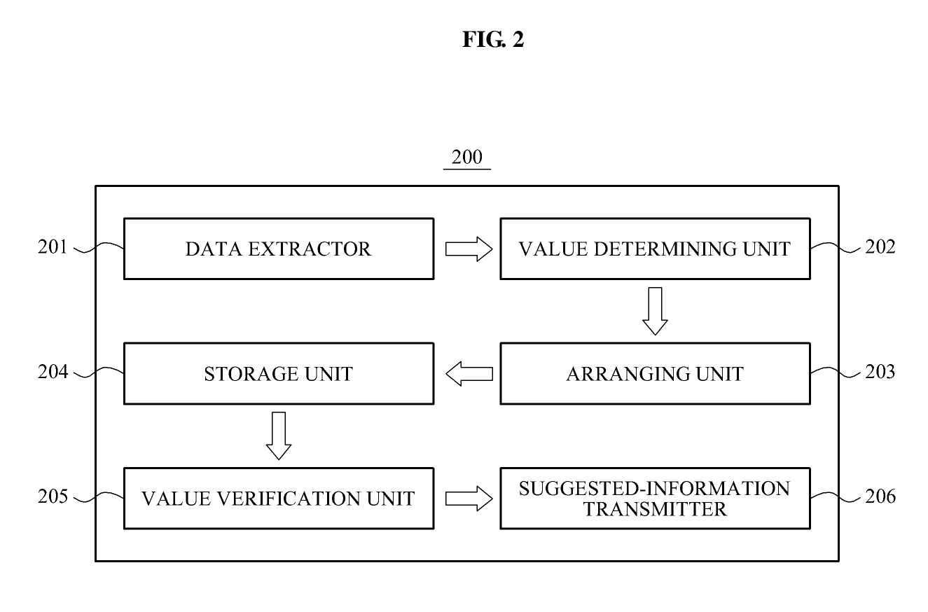

FIG. 2 is a block diagram illustrating an internal configuration of a system for determining a value 200 according to an exemplary embodiment of the present invention. The system for determining a value 200 according to an exemplary embodiment may correspond to the system for determining a value 100 of FIG. 1. Referring to FIG. 2, the system for determining a value 200 may include a data extractor 201, a value determining unit 202, an arranging unit 203, a storage unit 204, a value verification unit 205, and a suggested-information transmitter 206.

The data extractor 201 may extract advertisement data, from a database, to provide an advertisement service for registering and displaying the advertisement data of an advertiser. Here, the database included in an advertisement registration system, may include the free registration system 110 and the charged registration system 120 described with reference to FIG. 1.

The value determining unit 202 may determine a value for switching a service state of the advertisement data. Here, the advertisement data may include at least one of a locale name and a business type name. In this case, the value determining unit 202 may compute the value based on at least one weighting among a plurality of weightings that are determined based on the at least one of the locale name and the business type name and at least one function including the at least one weighting as a variable.

Here, the plurality of weightings may include at least one of a business weighting for each locale according to the locale name, a business weighting for each business type according to the business type name, a current sales weighting according to each of the locale name and the business type name, and an accumulated sales weighting according to each of the locale name and the business type name. In this instance, a value determined through an advertisement registration system that registers enterprise information for each locale and provides a display service at a charge may be used as the business weighting for each locale, the business weighting for each business type, the current sales weighting, and the accumulated sales weighting.

The at least one weighting among the plurality of weightings may include a popularity of each search query having the locale name or the business type name, and the popularity of each search query may be determined through a search system that provides a search result according to the search query. Here, the plurality of weightings may include various weightings used for determining a switching value of advertisement data other than the aforementioned weightings and popularity. For example, a weighting according to whether an enterprise corresponds to a chain may be used in the plurality of weightings.

In this instance, the value determining unit 202 may verify the plurality of weightings and compute a switching value using a function that includes a weighting as a variable. An example of computing the switching value using the function is expressed in the following Equation 1.

switching value=a*F(business weighting for each locale and business weighting for each business type)+b*G(current sales weighting according to each of locale name and business type name and accumulated sales weighting according to each of locale name and business type name)+c*H(popularity of each search query)+d*I(etc.)+e [Equation 1]

Here, each of F(x, y), G(x, y), H(x, y), and I(x, y) corresponds to a function using a weighting as a variable, and denotes a function for computing a switching value from weightings corresponding to x and y. Each of a, b, c, d, and e denotes a weighting given to each function. A function and a weighting given to the function may be selected and changed as necessary.

The arranging unit 203 may arrange the advertisement data according to a magnitude of the switching value. For example, the arranging unit 203 may arrange the advertisement data in a descending order of magnitude. That is, advertisement data having a relatively high switching value may be determined to have a relatively high order of priority for recommending a registration or an advertisement, and advertisement data arranged according to the order of priority for a recommendation may be generated.

The storage unit 204 may store the advertisement data related to the switching value. That is, the storage unit 204 may store advertisement data arranged through the arranging unit 203 and related to a switching value. The advertisement data that is arranged and stored related to the switching value may have a determined value, and be used as information for recommending an advertisement or an order of priority of a business.

The value verification unit 205 may verify, from the storage unit 204, a value for switching a service state of the advertisement data. For example, the value verification unit 205 may verify advertisement data having a switching value of a magnitude that is greater than or equal to a predetermined magnitude. Here, the predetermined magnitude may denote a minimum value of a switching value necessary for enabling the advertisement data to be used for recommending an advertisement or business activities, and the value verification unit 205 may verify only advertisement data having a switching value greater than or equal to the minimum value.

The suggested-information transmitter 206 may transmit suggested information for switching a service state using the switching value. In this instance, the suggested-information transmitter 206 may transmit the suggested information through an e-mail or a short message service (SMS), by extracting an e-mail address or a phone number from the verified advertisement data or information of the advertiser.

For example, the suggested-information transmitter 206 may select an advertiser registered free of charge to be switched to an advertiser charged a registration fee from among advertisers registered free of charge using the switching value, and transmit the suggested information to the selected advertiser. The suggested-information transmitter 206 may select an advertiser charged registration fees to be switched to an advertiser charged a relatively high price for a premium service from among advertisers charged registration fees using the switching value, and transmit the suggested information to the selected advertiser.

For example, the suggested information may be transmitted to the free registration system to be displayed through a free registration page when the advertiser logs in, on the free registration page. The suggested information may be transmitted to a charged registration system to be displayed through a charged registration page when the advertiser logs in, on the charged registration page so that the advertiser may be switched to a premium service. That is, a manager, and the like may use advertisement data stored in the storage unit 204, and further, the system for determining a value 200 may directly provide suggested information to an advertiser.

An object to which suggested information from the suggested-information transmitter 206 is transmitted may not be limited to an advertiser registering data or to a user, for example, an operator of a website associated with data that is displayed by a search engine. The suggested-information may also be delivered to a marketing department of an advertisement platform system that provides charged registration data. That is, when a switching value acceptable to an advertiser or a sales switching value acceptable to an advertisement platform satisfies a predetermined requirement, a suggested request for a switch to a charged service or an additional charge according to a data provision attribute may be delivered to the marketing department associated with the advertisement platform system. The suggested information may be delivered through a scheme of discriminating data having a switching value that satisfies a predetermined requirement from other data.

Thus, a system for determining a value according to an exemplary embodiment of the present invention may suggest a charged registration to an advertiser registered free of charge using a switching value corresponding to a switch of a service state. Further, the system for determining a value may suggest a premium service corresponding to a relatively high priced service to an advertiser registered for a fee using a switching value.

An advertiser may change a service state based on an objective data, through a switching value, thereby increasing profitability. An operator operating an advertisement registration system may suggest, to an advertiser, a charged service to be switched from a free service and a charged service at a relatively high price to be switched from a charged service at a relatively low price, thereby achieving an increased profit due to a service switch.

Data corresponding to an object for determining or estimating a value according to an exemplary embodiment of the present invention may not be limited to an object directly registered by an advertiser or a user. That is, an object automatically collected by a crawler that is used in a general search engine may be an object for estimating a switching value.

In arranging a general search result, expenses of advertisement information paid by an advertiser may be provided prior to unpaid information that is automatically collected by a crawler. In this case, suggested information for changing a display attribute, for example, an order of priority through switching to a charged service may be transmitted to a user operating a free site on a search list.

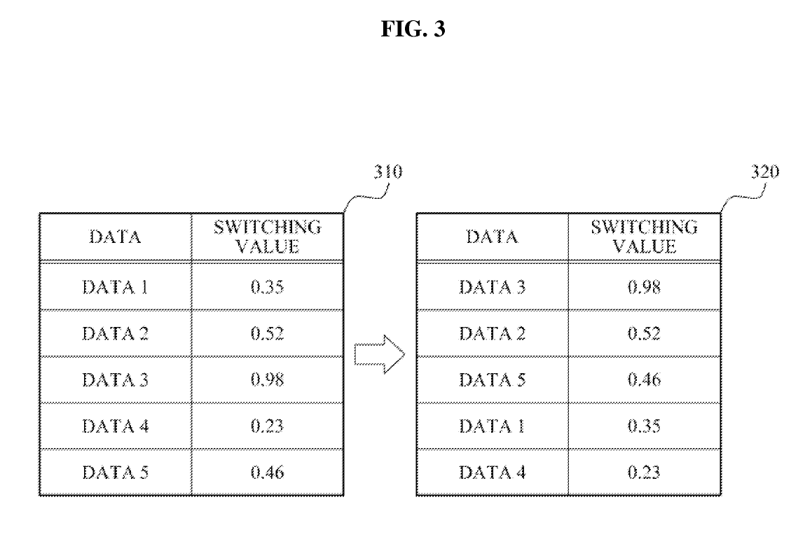

FIG. 3 is an example of arranging advertisement data according to a switching value determined by a system for determining a value according to an exemplary embodiment of the present invention. A first table 310 indicates switching values for advertisement data of “data 1” through “data 5,” and a second table 320 indicates that the “data 1” through the “data 5” are arranged in a descending order of switching values. That is, even though the “data 1” through the “data 5” initially registered through a free registration system may not have an order of priority used for a business, an order of priority for switching a service state of advertisement data may be imparted through the system for determining a value according to an exemplary embodiment of the present invention that determines the switching value as illustrated in the first table 310 and arranges the advertisement data according to a magnitude of the switching value as illustrated in the second table 320.

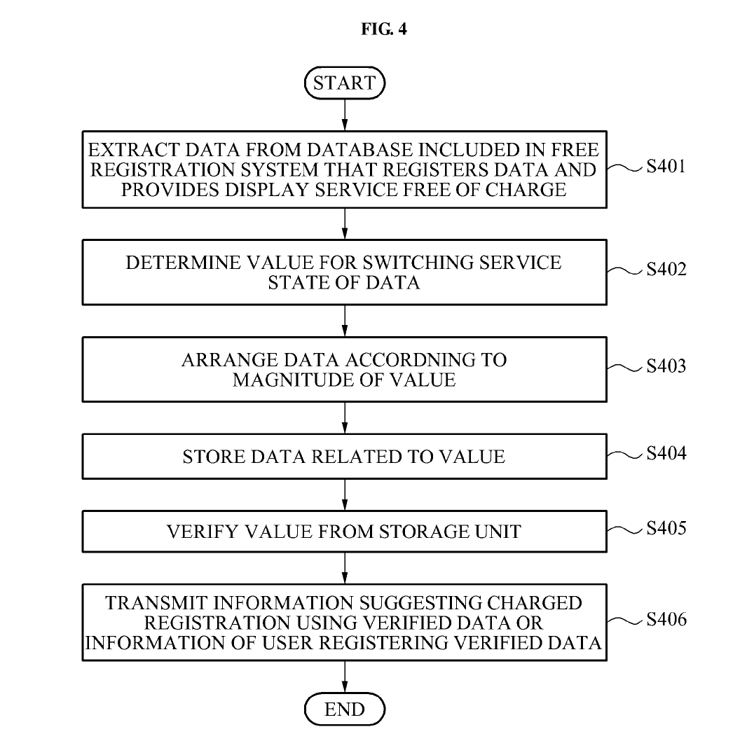

FIG. 4 is a flowchart illustrating a method of determining a value according to an exemplary embodiment of the present invention. The method of determining a value according to an exemplary embodiment of the present invention may be performed through the system for determining a value 200 described with reference to FIG. 2. The method of determining a value is described with reference to FIG. 4 by describing an operational flow of performing each operation through the system for determining a value 200. FIG. 4 illustrates a case of switching a service state from a free service to a charged service. As described in the foregoing, the present invention may be applied to a case of switching from a charged service at a relatively low price to a charged service at a relatively high price. The case of switching from a charged service at a relatively low price to a charged service at a relatively high price will be omitted in FIG. 4 for conciseness.

In operation S401, the system for determining a value 200 may extract advertisement data, from a database, to provide an advertisement service for registering and displaying the advertisement data. Here, the database may be included in the free registration system 110. That is, the system for determining a value 200 may extract advertisement data registered free of charge from the free registration system.

In operation S402, the system for determining a value 200 may determine a switching value according to a switch of a service state of the advertisement data. Here, the advertisement data may include at least one of a locale name and a business type name. In this case, the system for determining a value 200 may compute the switching value based on at least one weighting among a plurality of weightings that are determined based on the at least one of the locale name and the business type name, and at least one function including the at least one weighting as a variable.

Here, the plurality of weightings may include at least one of a business weighting for each locale according to the locale name, a business weighting for each business type according to the business type name, a current sales weighting according to each of the locale name and the business type name, and an accumulated sales weighting according to each of the locale name and the business type name. In this instance, a value determined through an advertisement registration system that registers enterprise information for each locale and provides a display service at a charge may be used as the business weighting for each locale, the business weighting for each business type, the current sales weighting, and the accumulated sales weighting.

The at least one weighting among the plurality of weightings may include a popularity of each search query having the locale name or the business type name, and the popularity of each search query may be determined through a search system that provides a search result according to the search query. The plurality of weightings may include various weightings used for determining a switching value of advertisement data other than the aforementioned weightings and popularity. For example, a weighting according to whether an enterprise corresponds to a chain store may be used as the plurality of weightings.

In this instance, the system for determining a value 200 may verify the plurality of weightings and compute a switching value using a function that includes a weighting as a variable.

In operation S403, the system for determining a value 200 may arrange the advertisement data according to a magnitude of the switching value. For example, the system for determining a value 200 may arrange the advertisement data according to a descending order of magnitude. That is, advertisement data having a relatively high switching value may be determined to have a relatively high order of priority for a recommendation of a registration or an advertisement, and advertisement data arranged according to the order of priority for a recommendation may be generated.

In operation S404, the system for determining a value 200 may store the advertisement data related to the switching value. That is, the system for determining a value 200 may store, in a storage unit included in the system for determining a value 200, advertisement data arranged in operation S403 and related to a switching value. The advertisement data that is arranged and stored related to the switching value may have a determined value, and be used as information for a recommendation of an advertisement or an order of priority of a business.

In operation S405, the system for determining a value 200 may verify, from the storage unit, advertisement data having the switching value whose magnitude is greater than or equal to a predetermined magnitude. Here, the predetermined magnitude may denote a minimum value of a switching value necessary for enabling the advertisement data to be used for a recommendation of an advertisement or business activities, and the system for determining a value 200 may verify only advertisement data having a switching value greater than or equal to the minimum value. The predetermined magnitude may be determined through a predetermined statistical scheme or a logic scheme, or may be arbitrarily determined by a manager.

In operation S406, the system for determining a value 200 may transmit suggested information that suggests a registration of a charged advertisement using the verified advertisement data or information of an advertiser registering the verified advertisement data. In this instance, the system for determining a value 200 may transmit the suggested information through an e-mail or an SMS, by extracting an e-mail address or a phone number from the verified advertisement data or the information of the advertiser.

The suggested information may be transmitted to the free registration system to be displayed through a free registration page when the advertiser logs in.

Thus, a method of determining a value according to an exemplary embodiment of the present invention may suggest a charged registration to an advertiser registered free of charge using a switching value according to a switch of a service state. Further, a method of determining a value may suggest a premium service corresponding to a relatively high priced service even to an advertiser registered for a fee using a switching value.

Through the switching value, an advertiser may change a service state based on an objective data, thereby achieving an increased profit. An operator operating an advertisement registration system may suggest, to an advertiser, switching from free service to a charged service and switching from a charged service at a relatively low price to a charged service in a relatively high price, thereby increasing profitability.

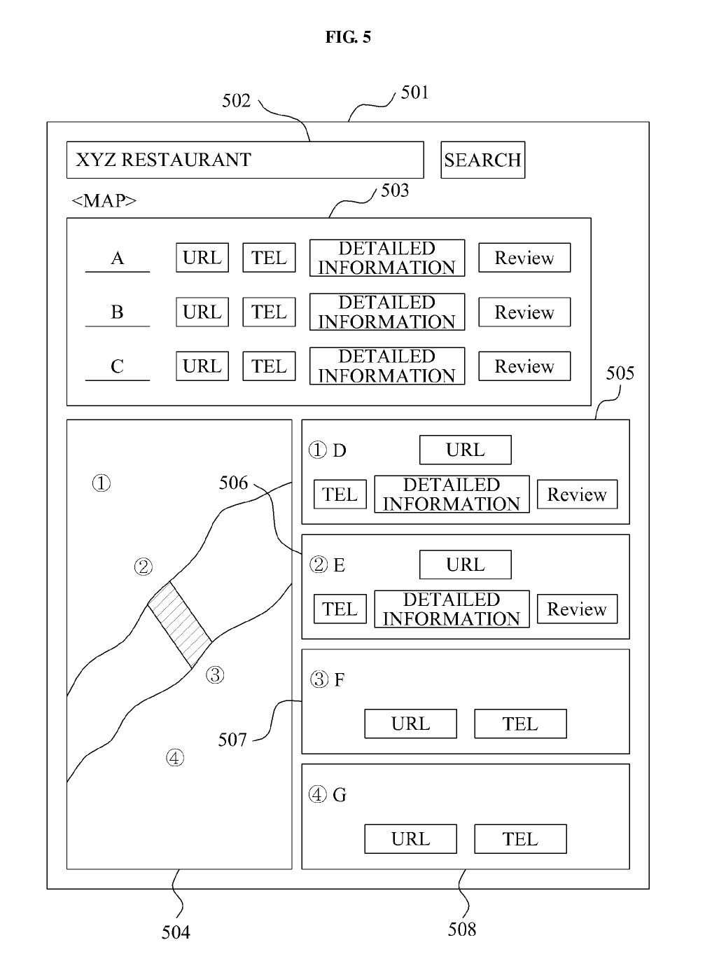

FIG. 5 is a diagram illustrating an example in which advertisement data of an advertiser registered free of charge, advertisement data of an advertiser who is charged a registration fee, and advertisement data of an advertiser registered as a premium service user are displayed in a search result according to an exemplary embodiment of the present invention.

FIG. 5 illustrates a search result page 501 in response to an input of “XYZ restaurant” by a user as a search query in a search window 502. Here, XYZ is assumed to be a locale name. The search result page 501 may display advertisement data of an advertiser with respect to a restaurant associated with the locale name XYZ. As described in the foregoing, advertisement data may include a locale name or a business type name. Advertisement data of an advertiser may be registered free of charge, registered for a fee, or registered in a premium service requiring an additional fee. The search result page 501 may include a location corresponding to advertisement data of an advertiser on a map 504.

Referring to FIG. 5, advertisement data A, advertisement data B, and advertisement data C of advertisers registered in a premium service are displayed through a list 503 at the top of the search result page 501. Advertisement data D and advertisement data E of advertisers registered in a charged service are displayed through a list 505 and a list 506, respectively next to the map 504 of the search result page 501. Advertisement data F and advertisement data G of advertisers registered in a free service are displayed through an inventory 507 and an inventory 508, respectively below the list 505 and the list 506 on the search result page 501.

That is, a premium service requiring a relatively high price may be displayed above a general charged service and a free service, thereby attracting a user more effectively. The premium service may have display attributes, for example, a font style, a font size, a color, a shade, and the like of letters changeable to various forms for attracting a user in comparison with the charged service and the free service, thereby more effectively attracting users to an advertisement.

For example, advertisement data of an advertiser registered in the premium service may be provided in a font that is eye-catching to a user, in a larger size in comparison with the charged service and the free service, in colored letters, or in a form emphasized by a boldface format.

An expression attribute of information included in advertisement data, for example, a uniform resource locator (URL), a phone number, a specification, and a review result may be changed when the premium service is used. A difference in a display location of advertisement data and an expression attribute of advertisement data may be present between the charged service and the free service. Information provided to a user through the free service may include a URL and a phone number, whereas information provided to a user through the charged service and the premium service may include a URL, a phone number, detailed information, and a review.

Due to a difference in effects of attracting users occurring for each service, an advertiser may desire to switch a current service state of advertisement data to a service state having a relatively high quality. According to an exemplary embodiment of the present invention, the system for determining a value may provide an advertiser with a switching value according to a switch of a service state of advertisement data, thereby motivating the advertiser to switch the service state. The advertiser may check the switching value of the advertisement data and determine whether to switch the service state of the advertisement data from the free service to the charged service or from the charged service to the premium service requiring an additional fee.

Through the aforementioned process, the advertiser may achieve an enhancement of profit due to an advertisement since an effect of attracting a user may be enhanced through advertisement data having a switched service state. An advertisement registration system may acquire a fee according to a switch of a service state since the advertiser may pay an additional fee according to the switch of a service state.

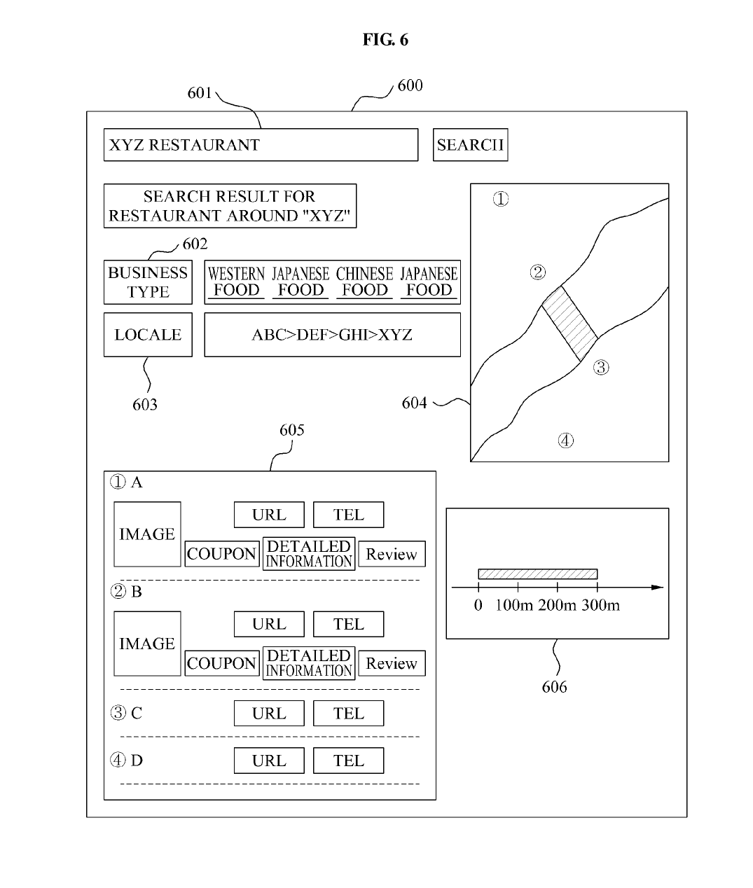

FIG. 6 is a diagram illustrating another example in which advertisement data of an advertiser is displayed in a search result according to an exemplary embodiment of the present invention.

FIG. 6 illustrates a search result page 600 when a user inputs a search query, for example, “XYZ restaurant” to a search window 601.

In response to the input, a search result for restaurants located around “XYZ” may be illustrated on the search result page 600. Restaurants may be specifically searched for in relation to business type 602 and for locale 603. A distance adjustment window 606 may enable a current user to adjust a radius from a retrieved location displayed on map 604, thereby enabling the user to adjust a search result according to a current location of the user.

Referring to FIG. 6, when a restaurant located around “XYZ” is assumed to be retrieved as advertisement data A, advertisement data B, advertisement data C, and advertisement data D, the advertisement data A and the advertisement data B of advertisers registered in a charged service may be located at a top of a list 605, and the advertisement data C and the advertisement data D of advertisers registered in a free service may be located at a bottom of the list 605. The advertisement data A and the advertisement data B registered in the charged service may include additional information, for example, an image, a coupon, detailed information, a review, and the like included in advertisement data in comparison with the advertisement data C and the advertisement data D registered in the free service. When advertisers of the advertisement data C and the advertisement data D switch service states by registering in the charged service, the advertisement data C and the advertisement data D may be provided with the charged service that is provided to the advertisement data A and the advertisement data B.

A system for determining a value according to an exemplary embodiment of the present invention may transmit, to the advertisers of the advertisement data C and the advertisement data D, a switching value according to a switch of a service state as suggested information for switching the service state, thereby enabling the advertisers to switch the service state of advertisement data.

Accordingly, through a switching value, an advertiser may switch a service state based on objective data, which leads to increased profitability for the advertiser. An operator operating an advertisement registration system may suggest, to the advertiser, switching from a charged service in a relatively low price to a charged service in a relatively high price, thereby achieving increasing profitability.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the well-known variety and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

It is to be understood that both the foregoing general description and the following detailed description are exemplary and explanatory and are intended to provide further explanation of the invention as claimed.

1. A system for determining a value, the system comprising:
a data extractor to extract advertisement data of an advertiser from a database and to provide an advertisement service for registering and displaying the advertisement data;
a value determining unit to determine a switching value for switching a service state of the extracted advertisement data; and
a storage unit to store the extracted advertisement data related to the switching value.

2. The system of claim 1, wherein:
the advertisement data comprises at least one of a locale name and a business type name, corresponding to an advertisement of the advertiser, and
the value determining unit computes the switching value based on at least one weighting among a plurality of weightings that are determined based on the at least one of the locale name, the business type name, and at least one function including the at least one weighting as a variable.

3. The system of claim 2, wherein the plurality of weightings comprises at least one of a business weighting for each locale according to the locale name, a business weighting for each business type according to the business type name, a current sales weighting according to each of the locale name and the business type name, and an accumulated sales weighting according to each of the locale name and the business type name.

4. The system of claim 2, wherein the at least one weighting among the plurality of weightings is determined through an advertisement registration system that registers enterprise information for each locale name and provides a display service.

5. The system of claim 2, wherein:
the at least one weighting among the plurality of weightings comprises a popularity of each search query having the locale name or the business type name, and
the popularity of each search query is determined through a search system that provides a search result according to the search query.

6. The system of claim 1, further comprising:
an arranging unit to arrange the advertisement data according to a magnitude of the switching value.

7. The system of claim 1, further comprising:
a data verification unit to verify the switching value for switching a service state of the advertisement data; and
a suggested-information transmitter to transmit suggested information for switching a service state using the switching value.

8. The system of claim 7, wherein the suggested-information transmitter transmits the suggested information through an e-mail and/or a short message service (SMS), by extracting an e-mail address and/or a phone number from the verified advertisement data or information of the advertiser.

9. The system of claim 7, wherein the suggested-information transmitter selects an advertiser to be switched to an advertiser charged a registration fee from among advertisers registered free of charge using the verified switching value, and transmits the suggested information to the selected advertiser.

10. The system of claim 7, wherein the suggested information is displayed through a free registration page in response to the advertiser logging onto the free registration page.

11. A method of determining a value, the method comprising:
extracting advertisement data, from a database, to provide an advertisement service for registering and displaying the advertisement data;
determining a switching value for switching a service state of the extracted advertisement data; and
storing the extracted advertisement data related to the switching value.

12. The method of claim 11, wherein:
the advertisement data comprises at least one of a locale name and a business type name, corresponding to an advertisement of an advertiser, and
the determining comprises computing the value based on at least one weighting among a plurality of weightings that are determined based on the at least one of the locale name, the business type name, and at least one function including the at least one weighting as a variable.

13. The method of claim 12, wherein the plurality of weightings comprises at least one of a business weighting for each locale according to the locale name, a business weighting for each business type according to the business type name, a current sales weighting according to each of the locale name and the business type name, and an accumulated sales weighting according to each of the locale name and the business type name.

14. The method of claim 12, wherein the at least one weighting among the plurality of weightings is determined through an advertisement registration system that registers enterprise information for each locale name and provides a display service for a fee.

15. The method of claim 12, wherein:
the at least one weighting among the plurality of weightings comprises a popularity of each search query having the locale name or the business type name, and
the popularity of each search query is determined through a search system that provides a search result according to the search query.

16. The method of claim 11, further comprising:
arranging the advertisement data according to a magnitude of the switching value.

17. The method of claim 11, further comprising:
verifying the switching value for switching a service state of the advertisement data; and
transmitting suggested information for switching a service state using the verified switching value.

18. The method of claim 17, wherein the transmitting comprises selecting an advertiser to be switched to an advertiser charged a registration fee from among advertisers registered free of charge using the verified switching value, and transmitting the suggested information to the selected advertiser.

19. A non-transitory computer-readable medium to determine a value, comprising a program for instructing a computer to perform the method of claim 11.
